(19) United States
(12) Patent Application Publication
(10) Pub. No.: US 2005/0176482 A1
(43) Pub. Date: Aug. 11, 2005

(54) Service station with vehicle communication capability

(76) Inventors: Vijay S. Raisinghani, Schaumburg, IL (US); Ramy P. Ayoub, Arlington Heights, IL (US)

Correspondence Address: MOTOROLA, INC., 1303 EAST ALGONQUIN ROAD, IL01/3RD, SCHAUMBURG, IL, 60196, US

(21) Appl. No.: 10/776,905

(22) Filed: Feb. 11, 2004

(51) Int. Cl. H04Q 7/20

(52) U.S. Cl. 455/575.9

(57) ABSTRACT

A system and method is provided for a communication system for a vehicle service station. The communication system includes a local area network (LAN) and a local communication device operable on the LAN for the vehicle service station. The invention is operable with a vehicle having a diagnostic system, a transceiver operable on the LAN, a transceiver operable on a wide area network (WAN), and a memory for storing information on the vehicle. The local communication device of the service station is operable to download information from the vehicle. Preferably, the WAN is used to direct the vehicle to perform a diagnostic which can be downloaded by the local communication device over the WAN.

### FIELD OF THE INVENTION

The present invention relates generally to communication systems. More particularly, the invention is directed to communicating service information between a service station and a vehicle.

### BACKGROUND OF THE INVENTION

Wireless communication technology, such as is used with cellular phones, is becoming much more sophisticated as the technology evolves. Presently, wireless communication systems and devices have the capability to not only provide communication between people, but also can acquire and provide different types of information between systems. Moreover this can be accomplished over a standard cellular network (wide area network) or over local area networks (e.g. IEEE 802.11, Bluetooth™, WiFi, etc.).

In addition, wide area networks (WAN) and local are networks (LAN) are being incorporated into vehicles. However, at this time LAN connectivity in a vehicle has been limited to in-vehicle systems. WAN connectivity in a vehicle include systems such as OnStar®, for example, where the On-Board Diagnostics (OBD II) of a vehicle can be queried by a remote site, to determine whether the vehicle is in need for service.

When it is determined that a vehicle needs service it is necessary for the driver of the vehicle to take the vehicle to a service station, where the vehicle and problems associated therewith are check-in. Although the vehicle identification number can be scanned in electronically, to be compared with a service station database for past information and service records, any presently existing conditions or changes in the vehicle must be entered manually by the service personnel.

Under normal circumstances the vehicle check-in process at a vehicle service station or dealership can be time consuming and slow. The process starts by waiting for the vehicle owner's turn in the queue. Once the owner's turn comes, the vehicle VIN (vehicle identification number) is noted along with the mileage and the owner's name. After this a list of things that need to be repaired or maintained to be done in the vehicle is noted. After that and if required, a diagnostic test is done, to determine any required repairs or scheduled maintenance. After that, an estimate is provided which needs to be approved before the vehicle is given the required service. This whole procedure of diagnosis, estimation and approval can consume much of the owner's time, depending on the availability of a technician, an available service bay to perform diagnostics, and lookup of repair costs. Essentially, this service call can waste much time, even before servicing the vehicle.

What is needed is a method and system to streamline the interaction between a service station and a vehicle owner. It would be an advantage to have the service station and vehicle automatically exchange necessary information therebetween. Specifically, it would be a benefit to utilize local area networks and wide area network to best advantage to bring about a time and cost savings for the check-in of a vehicle for service.

### BRIEF DESCRIPTION OF THE DRAWINGS

FIG. 1 illustrates a simplified diagram of a communication system, in accordance with the present invention;

FIG. 2 illustrates a first sample display menu, in accordance with the present invention;

FIG. 3 illustrates a second sample display menu, in accordance with the present invention; and

FIG. 4 is a flow chart illustrating a method for communication between a service station and a vehicle, in accordance with the present invention.

### DETAILED DESCRIPTION OF THE PREFERRED EMBODIMENTS

The present invention provides a method and system to streamline the interaction between a service station and a vehicle owner. Through the use of local area networks (LAN) and wide area networks (WAN), the service station and vehicle automatically exchange necessary information therebetween. Specifically, a wireless LAN-based check-in and diagnostics station is provided at a vehicle dealership or a service station. The wireless LAN based diagnostic system will communicate with the vehicle, through a Telematics system for example, and gather the vehicle information such as a vehicle identification number (VIN) and optional odometer reading.

Using the VIN number, the wireless LAN will check-in the vehicle for service and a diagnostics station can execute the vehicle diagnostics tests over the WAN via the Telematics system and check for any failure codes. Specifically, the service station can direct the vehicle diagnostic system to execute a known diagnostic. Additionally, the service station can download a particular diagnostic test application for the vehicle diagnostic system to execute. Once the diagnostics results and mileage are known, and optionally based on the service records maintained in the vehicle storage and/or the service station, an appropriate message regarding the repairs that need to be done can be provided to the driver of the vehicle via the wireless LAN network with an approximate estimate of the charges the vehicle owner may incur. Further, the suggested repairs and costs can be displayed on the vehicle's dash board, radio head unit, or any other display mechanism and request for vehicle owner's approval for the items individually. Additionally, audio prompts could be added or substituted for the display system in the vehicle. It is envisioned that the whole process of checking in a vehicle using the present invention can be done within five to ten minutes. Additionally, any service records can be saved in the vehicle's Telematics system memory as a maintenance or service history.

Essentially, the present invention will save time and cost of execution the service/diagnostics time for each customer. Additionally the service records can be maintained in the vehicle's Telematics system which makes it easier for the owner to maintain vehicle service records, and based on these, the dealership or service station can serve their clients better. The use of a LAN is used to advantage since, the process of setting up the service appointment would be almost automatic for the driver, whereas if all the communication were done over a WAN, for example, the driver would need to call up the service center and request to initiate the check-in process and so on. Also, in the present invention, the system is localized by the area surrounding the service station which assists automatic start of the check-in procedure.

The invention will have application apart from the preferred embodiments described herein, and the description is provided merely to illustrate and describe the invention and it should in no way be taken as limiting of the invention. While the specification concludes with claims defining the features of the invention that are regarded as novel, it is believed that the invention will be better understood from a consideration of the following description in conjunction with the drawing figures, in which like reference numerals are carried forward. As defined in the invention, a communication device can be a portable, mobile, or fixed radiotelephone, personal digital assistant or computer. In general, the present invention is equally adaptable to any communication device and user interface, be they wireless or wireline.

The concept of the present invention can be advantageously used on any electronic product with data transfer. Preferably, the radiotelephone portion of the communication device is a cellular radiotelephone adapted for personal communication, but may also be a pager, cordless radiotelephone, or a digital communication cellular radiotelephone. The radiotelephone portion is constructed in accordance with known communication standards for cellular networks (i.e. WAN) and local area networks, as are known in the art, or future digital communication standards that are presently being developed. The radiotelephone portions of the system generally include a radio frequency (RF) transceiver, memory, a digital signal processor, and a microprocessor. The electronics incorporated into a cellular phone, two-way radio or selective radio receiver, such as a pager, are well known in the art, and can be incorporated into the communication device of the present invention.

Many types of digital communication devices can use the present invention to advantage. By way of example only, the communication device is embodied in a cellular phone having a conventional cellular radio transceiver circuitry along with local area network capability, as is known in the art, and will not be presented here for simplicity. The cellular telephone includes conventional cellular phone hardware (also not represented for simplicity) such as processors and user interfaces that are integrated in a compact housing or associated with a Telematics unit, and further includes a microprocessor and digital processing circuitry, in accordance with the present invention. Each particular wireline or wireless device will offer opportunities for implementing this concept and the means selected for each application.

A series of specific embodiments are presented, ranging from the abstract to the practical, which illustrate the application of the basic precepts of the invention. Different embodiments will be included as specific examples. Each of which provides an intentional modification of, or addition to, the method and apparatus described herein.

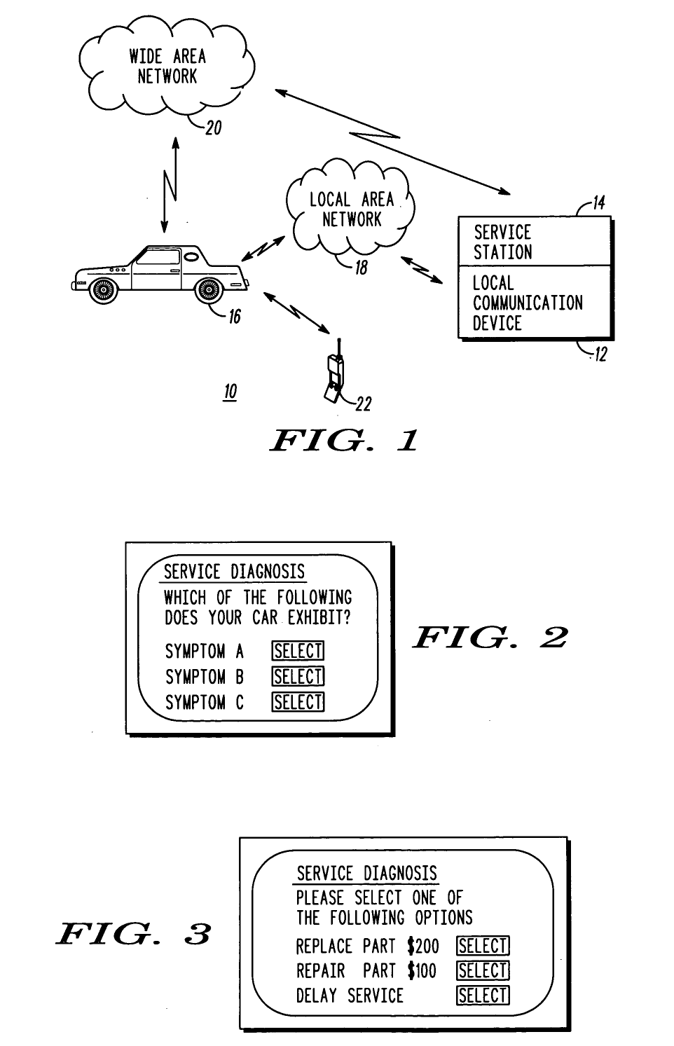

Referring to FIG. 1, the present invention is a communication system 10 between a local communication device 12 in a service station 14 or automobile dealership and a vehicle 16. The present invention is applicable for those communication devices 12, 16 operable on a common local area network (LAN) 18, such as IEEE 802.11, Bluetooth™, WiFi, and the like, as are known in the art. In addition, the present invention is also applicable to a wired local network. Preferably, a WiFi wireless local area network is used as it has a larger coverage are suitable for a service station environment. The WiFi network is supported and supplied by the service station 14. Optionally, the service station could utilize a separate handheld device 22, such as a personal digital assistant (PDA) or cellular phone to communicate with the vehicle 16, either directly or through the LAN 18.

The vehicle 16 incorporates a diagnostic system for detecting faults in the operation of the vehicle, a transceiver operable on the LAN, and a memory for storing information on the vehicle. The service station incorporates a computer system with a database on vehicles serviced by the service station. The database includes identification and ownership information associated with particular vehicles. The database can also have stored service history information about past services performed on particular vehicles.

The local communication device 12 for the vehicle service station 14 is operable on the LAN 18 and operable to download the information from the vehicle 16 through the vehicle LAN transceiver. In particular, the diagnostic system can store any diagnostic information in the memory, which can be transferred through the vehicle LAN transceiver and LAN to the local communication device 12, upon request. The communication protocols to provide such download are known in the art for the particular LAN system used (e.g. WiFi), and will not be presented here.

In practice, the local communication device is to query for any vehicle LAN transceiver within a coverage area of the service station LAN. Preferably, an acknowledgement and authentification protocol is used to prevent unauthorized access to vehicle information for increased security. The query can be initiated automatically or manually. In addition, the query can be repeated continually or intermittently. The query would direct the vehicle to supply information from the vehicle memory to the service station. Specifically, the information would include an identification of the vehicle, such as by vehicle identification number (VIN), for example, or similar identifier that uniquely identified the vehicle and an odometer reading. Any other available information can also be provided in response to the query, such as On-Board Diagnostic (OBD II) codes for example. Further, the query can include instructions as to the specific information to be transferred. Preferably, when this automatic vehicle check-in and diagnostics are occurring, a message is displayed and/or an audio indication played indicating service station transactions are in progress. For example, the message can be displayed as a ticker message or background message on the radio head unit.

The service station computer can retrieve the information downloaded from the vehicle and correlate the identification information with ownership information in the local database. The service station computer can also compare mileage information from the vehicle with the local database to determine whether any scheduled maintenance is due on the vehicle.

In a preferred embodiment, the vehicle 16 includes a transceiver operable on a wide area network (WAN) 20 of a network (i.e. cellular) service provider and the local communication device 12 is also operable on the WAN 20. Vehicle WAN transceivers are known (e.g. Telematics), and therefore their particular mode of operation will not be presented here. The Telematics device can communicate information to the vehicle using an in-vehicle communication channel and to the vehicle LAN transceiver. In this embodiment, the local communication device 12 can direct the vehicle diagnostic system, over the WAN 20, to perform general or specific vehicle diagnostic. The vehicle is configured to respond to the diagnostic command from the service station by executing the indicated diagnostic routine and downloading the results of the diagnostic back to the local communication device 12 over the WAN 12. In particular, In this way, the service station can provide an active search for specific problems with the vehicle instead of passively downloading data from the vehicle memory.

Optionally, the local communication device 12 can direct the vehicle diagnostic system, over the LAN 18, to perform vehicle diagnostics and to download results of the diagnostics back to the local communication device 12 over the LAN 12. Further, the local communication device 12 can direct the vehicle diagnostic system, over the LAN 18 or WAN 20, to perform vehicle diagnostics and to download results of the diagnostics back to the local communication device 12 over the WAN 12 or LAN 18, respectively. It is preferred that information transfer is done automatically over the LAN, and any diagnostics are done remotely over the WAN, inasmuch as LAN downloading requires no user interaction, and WAN systems already exists (e.g. OnStar®) to communicate with the vehicle electronics.

If there is not enough information, from the active or passive information obtain from the vehicle over the LAN or WAN, to make a recommendation as to the required service, the service station computer can initiate an interactive session with a driver of the vehicle over a user interface of the vehicle. The user interface can include an audio speaker and microphone in the vehicle or a video device therein.

FIG. 2 illustrates an example of an interactive session over a user interface display of the vehicle, for example. In this case, the service station computer can communicate over the LAN and send a request for further information from the driver of the vehicle. In many cases, a particular problem in the vehicle can have many different causes. In order to narrow down the possible causes and to diagnose the service needed, the user interface can ask, for example, “Which of the following symptoms does your car exhibit?” and present the driver with several choices derived from an online database for that particular problem. The driver can then select particular choices, which can be transmitted back the service station computer over the LAN. The service station computer can then analyze this new information to arrive at a particular service diagnoses. When at least one service procedure can be determined, the local communication device is operable to send information regarding the determined service for the vehicle to the user interface of the vehicle through the LAN and LAN transceiver.

FIG. 3 illustrates an example of a service analysis display to a driver of a vehicle over a user interface display, for example. In this case, the service station computer can propose at least one service over the LAN and send a request for approval from the driver of the vehicle. In reply, the user interface is operable to allow approval of a particular service to the local communication device through the LAN transceiver and LAN. For example, the user interface can ask a driver, for example, “Please select one of the following service options” and present the driver with several choices derived from an online database for that particular service. In this case, the driver can choose to replace or repair a specific part, or act to defer service. The driver can then select a desired service option, which can be transmitted back the service station computer over the LAN.

Subsequent, to any service performed on the vehicle, the service station can upload the service performed to the vehicle memory, which is operable to store a service history record of the vehicle. The service history record data can then be downloaded from the vehicle memory to the local communication device, or to any other service station or dealership that the driver may visit. Optionally, when any vehicle information is to be downloaded, a message indicating the same can be transmitted to a user interface of the vehicle and played on audio or displayed on the radio, dash board, or head unit. Upon such indication, the driver of the vehicle can disallow the download if desired.

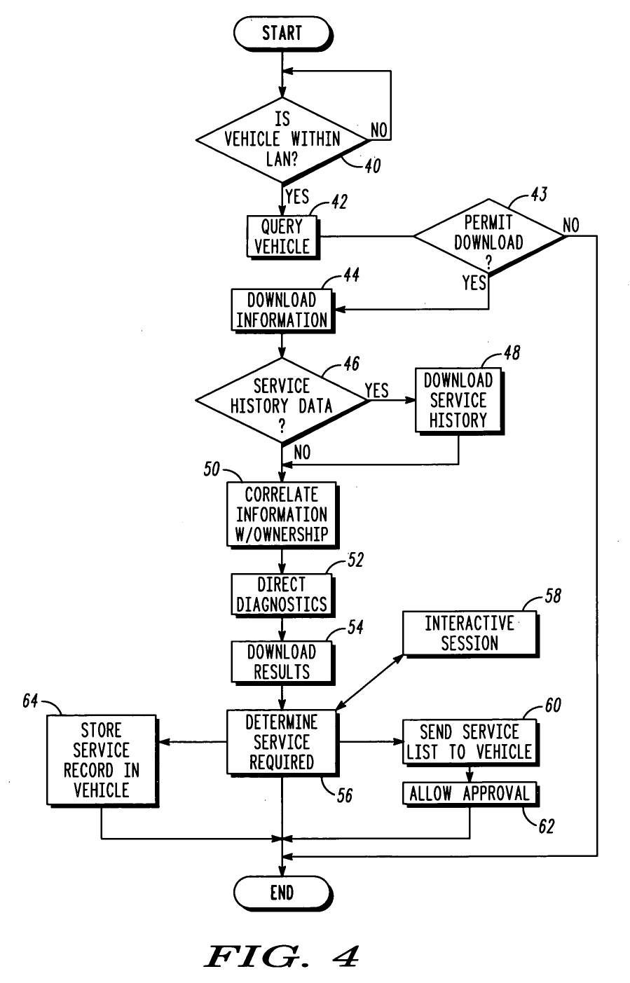

Referring to FIG. 4, the present invention also incorporates a method for communication between a service station and a vehicle, wherein the vehicle is equipped with a transceiver operable on a local area network (LAN), a diagnostic system, and a memory for storing information on the vehicle. The service station also uses a local communication device to support and operate on the LAN. LAN system are known and include IEEE 802.11, Bluetooth™, WiFi, and the like, as are known in the art, but the present invention is also applicable to a wired local network. Preferably, a WiFi wireless local area network is supported and supplied by the service station. Optionally, the service station could utilize a separate handheld device, such as a personal digital assistant (PDA) or cellular phone to communicate with the vehicle, either directly or through the LAN. Additionally, the user has the option to record any service records manually via any other wireless LAN capable device or via the vehicle interface. Further, the present invention envisions the provision for data synchronization between any service station and the vehicle and/or any other wireless LAN capable device, such as is known in the art between PDAs and computers.

A first step 40 of the method is to detect any LAN transceivers, such as can be found in some vehicles, within the vicinity of the LAN network established by the service station. This step can be performed continuously or intermittently. Once a vehicle establishes itself on the LAN, using known protocols that will not be presented here, the service station can the query 42 the vehicle LAN transceiver within the coverage area of the service station LAN to download information from the vehicle. This query can be repeated continually or intermittently. The query would direct the vehicle to supply information from the vehicle memory to the service station for downloading 44 over the LAN. Specifically, the information would include an identification of the vehicle, such as by vehicle identification number (VIN), for example, or similar identifier that uniquely identified the vehicle and an odometer reading. Any other available information can also be provided in response to the query, such as On-Board Diagnostic (OBD II) codes for example. Further, the query can include instructions as to the specific information to be transferred.

The service station can download 44 the information from the vehicle and check 46 if there is any service history data. If service history data exists then the service station will download 48 this data also. The service history data can be retrieved from either or both of the service station database or the vehicle memory. The service station can the correlate 50 the identification information with ownership information in a local database. The service station computer can also compare mileage information from the vehicle with the local database to determine whether any scheduled maintenance is due on the vehicle.

In a preferred embodiment, the service station can direct 52 the vehicle diagnostic system to perform a general or specific vehicle diagnostic. This can be done over the LAN, but preferably is accomplished over a vehicle transceiver and service station transceiver operable on a wide area network (WAN) of a network (i.e. cellular) service provider. The vehicle can then respond to the diagnostic command from the service station by executing an indicated diagnostic routine and downloading 54 the results of the diagnostic back to the local communication device over the WAN.

The method then proceeds to determine 56 the service required on the vehicle. If there is not enough information to determine the service, from the active or passive information obtain from the vehicle over the LAN or WAN, then the service station computer can initiate 58 an interactive session with a driver of the vehicle to better determine the service required (as previously explained in regards to FIGS. 2 and 3). When at least one service procedure can be determined, the service station sends 60 information regarding the determined service for the vehicle to the driver of the vehicle for selection. In reply, the service station can allow 62 the driver select and approve a particular service and a service time, which can be transmitted back the service station.

Subsequent, to any service performed on the vehicle, the service station can upload and store 64 the service performed in the vehicle memory, which is operable to store a service history record of the vehicle. The service history record data can then be downloaded 48 from the vehicle memory to any other service station or dealership that the driver may subsequently visit. Optionally, when any vehicle information is to be downloaded, a message indicating the same can be transmitted to a user interface of the vehicle and played on audio or displayed on the radio, dash board, or head unit. Upon such indication, the driver of the vehicle can disallow 43 the download if desired.

The present invention provides a method and system to provide seamless service communication with minimum driver involvement. All the above mentioned sequence of operations can be done remotely while the driver is seated in the vehicle and pulling up the car in front of the service station while waiting in queue. The advantage of such a system is that by the time the driver actually pulls to the head of the queue all the required information will be ready waiting for his approval of service. Further, for vehicles that are passing by the service stations, this mechanism could be used as an alert for any scheduled maintenance like oil changes etc. Additionally, this will be more profitable for the service station as well as the actual labor saved will more than recoup the one-time investment in the necessary hardware.

While the foregoing described embodiments have been set forth above, it will be appreciated to one skilled in the art that the invention described has applications beyond the described embodiments. Accordingly, it is intended that the scope of the invention including such alternatives, modifications, and variations contemplated shall be defined by the appended claims.

1. A communication system for a vehicle service station, the communication system comprising:
a local area network (LAN);
a vehicle having a diagnostic system, a transceiver operable on the LAN, and a memory for storing information on the vehicle; and
a local communication device for the vehicle service station, the local communication device operable on the LAN and operable to download the information from the vehicle.

2. The communication system of claim 1, wherein the LAN is a wireless LAN and the local communication device is to query for the vehicle transceiver within a coverage area of the LAN.

3. The communication system of claim 1, wherein the LAN is a wireless LAN and the communication system operates such that the local communication device synchronizes service records with the vehicle.

4. The communication system of claim 1, wherein the local communication device queries a vehicle for identification information and provides the identification information for correlation with ownership information in a local database.

5. The communication system of claim 1, wherein the vehicle includes a transceiver operable on a wide area network (WAN) of a network service provider and the local communication device is operable on the WAN, and wherein the local communication device can direct the vehicle diagnostic system, over the WAN, to perform vehicle diagnostics and to download results of the diagnostics back to the local communication device over the WAN.

6. The communication system of claim 5, wherein the local communication device is operable to download a particular diagnostic test application over the WAN for the vehicle diagnostic system to execute.

7. The communication system of claim 5, wherein the local communication device is operable to send information regarding service for the vehicle to a user interface of the vehicle through the LAN and LAN transceiver.

8. The communication system of claim 7, wherein the user interface is operable to allow approval of service to the local communication device through the LAN transceiver and LAN.

9. The communication system of claim 1, wherein the memory of the vehicle is operable to store service record data of the vehicle and is used to download the service record data from the vehicle memory to the local communication device.

10. The communication system of claim 1, wherein, when any vehicle information is to be downloaded, a message indicating the same can be transmitted to a user interface of the vehicle such that a driver of the vehicle can disallow the download if desired.

11. A communication system for a vehicle service station, the communication system comprising:
a wireless local area network (LAN);
a vehicle having a diagnostic system, a transceiver operable on the local area network, a transceiver operable on a wide area network (WAN) of a network service provider, and a memory for storing information on the vehicle; and
a local communication device for the vehicle service station, the local communication device operable on the LAN and operable to query for vehicle transceivers within a coverage area of the LAN and to download the information from the vehicle.

12. The communication system of claim 11, wherein the information contains at least one of a vehicle identification number and an odometer reading, and wherein the local communication device provides the information for correlation with ownership information in a local database.

13. The communication system of claim 11, wherein the local communication device is operable on the WAN, and wherein the local communication device can direct the vehicle diagnostic system, over the WAN, to perform vehicle diagnostics and to download results of the diagnostics back to the local communication device over the WAN.

14. The communication system of claim 11, wherein the local communication device is operable to send information regarding service of the vehicle to a user interface of the vehicle through the LAN and LAN transceiver, and to allow approval of service to the local communication device through the user interface, LAN transceiver and LAN.

15. The communication system of claim 11, wherein the memory of the vehicle is operable to store service record data of the vehicle and is used to download the service record data from the vehicle memory to the local communication device.

16. The communication system of claim 11, wherein the local communication device and the user interface are operable to provide an interactive session with a driver of the vehicle to assist in determining required service.

17. A method for communication between a service station and a vehicle with a transceiver operable on a local area network, a diagnostic system, and having a memory for storing information on the vehicle, the method comprising the steps of:
querying for a vehicle local area network transceiver within a coverage area of a local area network;
downloading identification information from the memory over the local area network; and
determining service required for the vehicle.

18. The method of claim 17, further comprising the step of correlating the identification information with ownership information in a local database.

19. The method of claim 17, wherein the vehicle includes a transceiver operable over a wide area network, and wherein the determining step includes the substeps of:
directing the vehicle diagnostic system, over a wide are network, to perform vehicle diagnostics; and
downloading the results of the diagnostics over the wide area network.

20. The method of claim 17, further comprising the steps of:
sending information regarding service of the vehicle to the vehicle through the local area network; and
allowing approval of service from the vehicle through the local area network.

21. The method of claim 17, further comprising the steps of:
storing service record data of the vehicle; and
downloading the service record data from the vehicle memory.

22. The method of claim 17, wherein the determining step includes an interactive session with a driver of the vehicle to assist in determining the service required.
